(19) United States
(12) Patent Application Publication
(10) Pub. No.: US 2017/0174112 A1
(43) Pub. Date: Jun. 22, 2017

(54) NESTING TILT-TRUCK

(71) Applicant: AKRO-MILS, a division of Myers Industries, Inc., Akron, OH (US)

(72) Inventors: Robert Sadinski, Tallmadge, OH (US); Travis Shamp, Akron, OH (US); Thomas Riems, Norwalk, OH (US); Scott Wiley, Medina, OH (US)

(21) Appl. No.: 15/381,203

(22) Filed: Dec. 16, 2016

Related U.S. Application Data
(60) Provisional application No. 62/269,167, filed on Dec. 18, 2015.

(51) Int. Cl. B60P 1/28; B60P 3/06

(52) U.S. Cl. CPC B60P 1/28; B60P 3/06

(57) ABSTRACT

A nesting tilt-truck includes a metal frame and a container body. A pair of large wheels are rotatably mounted on a common axle that is in turn mounted on the metal frame near the junction of the container body front wall and base. A second caster wheel or wheels, which house a self-contained axle that allows the wheel(s) to rotate, is mounted on the metal frame near the junction of the container body rear wall and base. The caster wheel(s) are configured to pivot about a vertical axis in order to easily steer the tilt-truck during use of the tilt-truck. The container body is formed with a kick-out wall that inclines rearwardly to form a pocket for seating the wheels of a second tilt-truck when one tilt-truck is nested inside a second tilt-truck.

### CROSS-REFERENCE TO RELATED APPLICATIONS

This application claims the benefit of U.S. Provisional Patent Application Ser. No. 62/269,167, which was filed on Dec. 18, 2015.

### BACKGROUND OF THE INVENTION

Technical Field

The present invention relates to the art of industrial storage and transport systems. More, particularly, the present invention relates to large wheeled containers, commonly referred to as “tilt-trucks,” for holding, transporting and dumping heavy or bulky materials. Even more particularly, the present invention is directed to a tilt-truck that includes an inclining kick-out wall that provides nesting support to the tilt-truck wheels when multiple tilt-trucks are nested within one another during transport or shipping of the tilt-truck. The combination of the inclined kick-out wall and a fulcrum extending from the front of the metal frame of the tilt-truck prevents longitudinal and lateral movement of a second tilt-truck of the present invention nested within a first tilt-truck of the present invention. The nesting tilt-truck of the present invention provides simplified nesting and removal of a first tilt-truck nested within a second tilt-truck that allows multiple tilt-trucks to be nested on top of one another during shipping and or transport of the tilt-truck in order to save space.

Background Art

Prior art tilt-trucks typically comprise a plastic container body having a horizontal base, a pair of generally identical vertical sidewalls transversely spaced from each other and extending upwardly from the base, and a rear wall and a front wall that are longitudinally spaced from one another and that also extend upwardly from the base. The front and rear walls, the sidewalls and the base are integrally formed with one another to form a generally box shape. The rear wall is typically oriented in a generally vertical configuration. The front wall is typically angled away from the horizontal base of the container body to allow easy tilting of the container body. The container body typically is mounted on and attached to a metal frame that includes a pair of front wheels and either a single rear wheeled caster located at the mid-line below the rear wall or a pair of rear wheeled casters located below the lower corners of the rear wall. The front wheels of the tilt-truck are generally larger than the rear wheeled caster(s) and are located generally adjacent to the angled front wall. The large front wheels aid in allowing the tilt-truck to tilt in order to provide easy dumping of the bulk contents of the tilt-truck during use. A handle typically extends from both the front and rear of the tilt-truck to allow for easy manipulation of the tilt-truck by an individual during use. The front and rear handles can be integrally formed with the container body or they can also be integrally formed with the metal frame.

Prior art tilt-trucks are typically utilized for transporting bulk goods that are heavy, and the wheeled tilt-truck allows for easy transport of the goods as well as easy dumping of the goods by the tilt-truck user. Prior art tilt-trucks, such as the one described above, do not nest within one another so that shipping or transport of the tilt-trucks can be quite inefficient and difficult.

Moreover, because of their generally large size, the prior art tilt-trucks are also not capable of being easily stacked on top of one another during transport or shipment, which also makes shipping and/or transport of the tilt-truck difficult.

A need exists in the art for a tilt-truck that can be easily nested within another tilt-truck in order to provide more efficient space management during transport or shipping of the tilt-trucks.

The nesting tilt-truck of the present invention accomplishes these needs and provides a tilt-truck that readily nests within a second tilt-truck, generally preventing longitudinal and lateral movement of the tilt-trucks nested within each other, so that multiple tilt trucks can be shipped or transported while nested together, saving space and providing for more efficient transport and shipment of the tilt-trucks.

### BRIEF SUMMARY OF THE INVENTION

An objective of the present invention is to provide a tilt-truck that provides nesting support to the tilt-truck wheels when multiple tilt-trucks are nested within one another during transport or shipping of the tilt-truck.

Another objective of the present invention is to provide a tilt-truck that prevents longitudinal and lateral movement of a second tilt-truck of the present invention nested within a first tilt-truck of the present invention.

Yet another objective of the present invention is to provide a tilt-truck that provides simplified nesting and removal of a first tilt-truck nested within a second tilt-truck.

Yet another objective of the present invention is to provide a tilt-truck that allows multiple tilt-trucks to be nested on top of one another during shipping and or transport of the tilt-truck in order to save space.

These objectives and others are obtained by the nesting tilt-truck of the present invention which includes a body, the body including a base, a rear wall integrally formed with the base, a first sidewall integrally formed with the base and the rear wall, a second sidewall integrally formed with the base and the rear wall, the second sidewall transversely spaced from the first sidewall, and a front wall integrally formed with the base, the first sidewall, and the second sidewall, and one or more wheels attached to the body, the tilt-truck body having an interior space which accommodates nesting of a second tilt-truck within the body, the tilt-truck having an exterior profile which enables the tilt-truck to be nested within an interior space of the second tilt-truck.

### BRIEF DESCRIPTION OF THE SEVERAL VIEWS OF THE DRAWINGS

The preferred embodiment nesting tilt-trucks of the present invention, illustrative of the best modes in which Applicant has contemplated applying the principles of the present invention, are set forth in the following description and are shown in the drawings, and are particularly and distinctly pointed out and set forth in the claims.

FIG. 1 is a front elevational view of a first exemplary embodiment nesting tilt-truck of the present invention, showing the generally angled front wall of the tilt-truck as well as the front handle;

FIG. 2 is a side elevational view of the first exemplary embodiment nesting tilt-truck of the present invention, showing the kick-out formed in the sidewall for accommodating the wheels of a second tilt-truck nested within the first tilt-truck;

FIG. 3 is a rear elevational view of the first exemplary embodiment nesting tilt-truck of the present invention, showing the metal frame extending upwardly along the rear wall of the container body, and showing a rear handle connected to the metal frame;

FIG. 4 is a top plan view of the first exemplary embodiment nesting tilt-truck of the present invention, showing the interior of the container body of the tilt-truck;

FIG. 5 is a bottom plan view of the first exemplary embodiment nesting tilt-truck of the present invention, showing the front and rear wheels rotatably mounted on the metal frame;

FIG. 6 is a perspective view of the first exemplary embodiment nesting tilt-truck of the present invention;

FIG. 7 is a side elevational view of a pair of first exemplary embodiment nesting tilt-trucks of the present invention nested together in an upside-down configuration;

FIG. 8 is a front elevational view of the pair of first exemplary embodiment nesting tilt-trucks shown in FIG. 7;

FIG. 9 is a top front perspective view of the pair of first exemplary embodiment nesting tilt-trucks shown in FIG. 7;

FIG. 10 is a top plan view of the pair of first exemplary embodiment nesting tilt-trucks shown in FIG. 7;

FIG. 11 is a rear elevational view of the pair of first exemplary embodiment nesting tilt-trucks shown in FIG. 7;

FIG. 12 is a bottom plan view of the pair of first exemplary embodiment nesting tilt-trucks shown in FIG. 7;

FIG. 13 is a view similar to FIG. 8, showing the pair of first exemplary embodiment nesting tilt-trucks in section along line B-B in FIG. 14;

FIG. 14 is a view similar to FIG. 7, showing the pair of first exemplary embodiment nesting tilt-trucks in section along line A-A in FIG. 13;

FIG. 15 is a side elevational view of a pair of second exemplary embodiment tilt-trucks of the present invention with portions of the tilt-trucks shown with hidden lines, showing the tilt-trucks nested one inside the other;

FIG. 16 is a top front perspective view of the pair of second exemplary embodiment tilt-trucks of the present invention shown in FIG. 15, showing the tilt-trucks nested one inside the other;

FIG. 17 rear elevational view of the pair of second exemplary embodiment tilt-trucks of the present invention shown in FIG. 15 with portions of the tilt-truck represented by dashed lines, showing the tilt-trucks nested one inside the other;

FIG. 18 is a top plan view of the pair of second exemplary embodiment tilt-trucks of the present invention shown in FIG. 15;

FIG. 19 is a top rear perspective view of a plurality of second exemplary embodiment tilt-trucks of the present invention, showing the tilt-trucks inverted, nested within one another and stacked on a wooden pallet;

FIG. 20 is a side elevational view of the second exemplary embodiment tilt-trucks of the present invention shown in FIG. 19, showing portions of the tilt-trucks represented by dashed lines;

FIG. 21 is a rear elevational view of the second exemplary embodiment tilt-trucks of the present invention shown in FIG. 19; and

FIG. 22 is a top plan view of the second exemplary embodiment tilt-trucks of the present invention shown in FIG. 19.

Similar numerals refer to similar parts throughout the drawings.

### DETAILED DESCRIPTION OF THE INVENTION

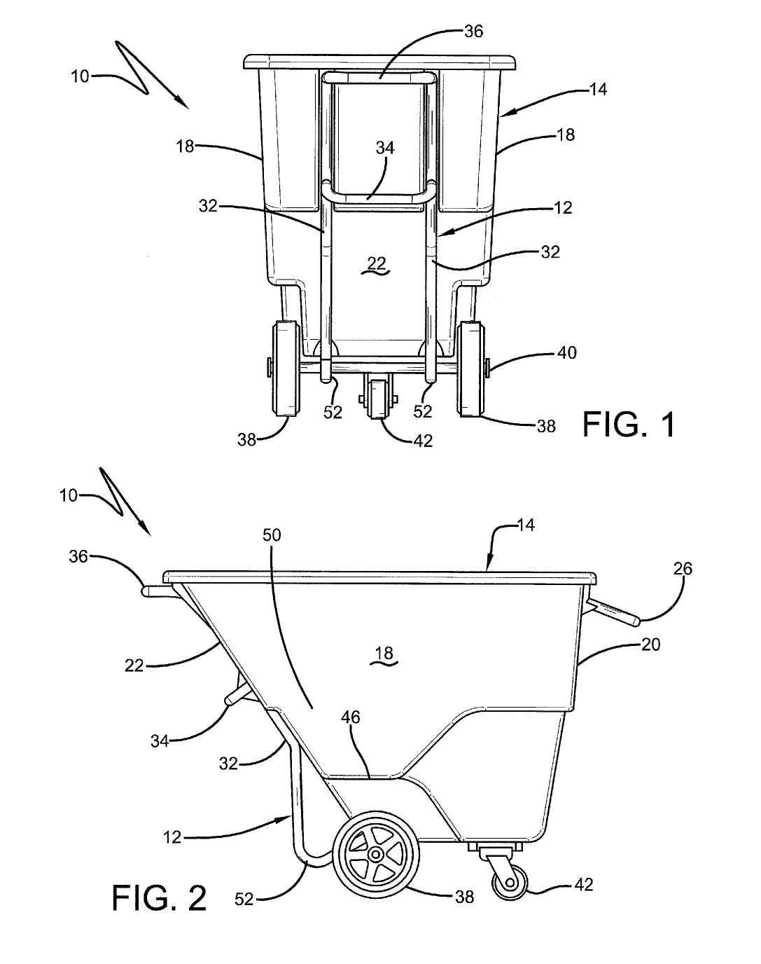

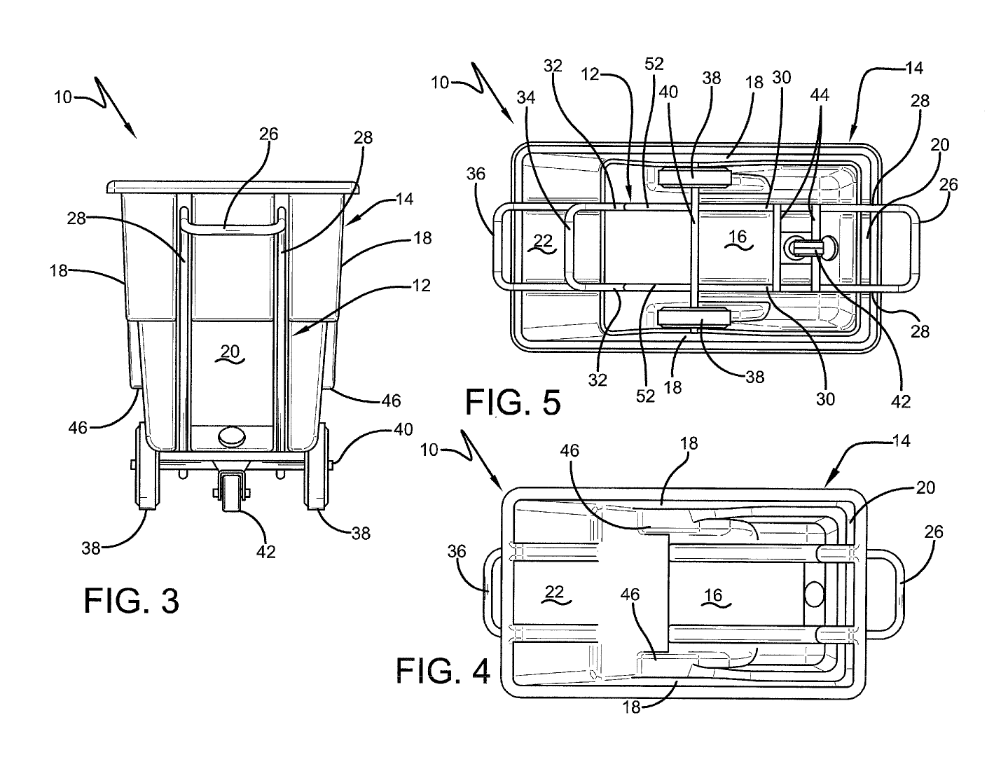

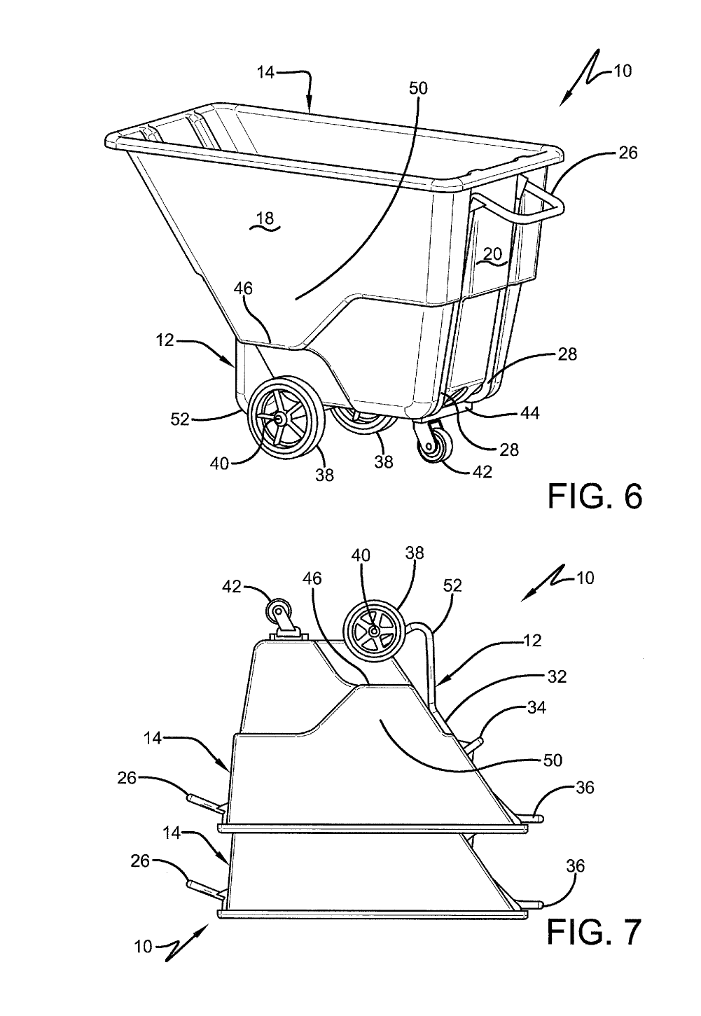

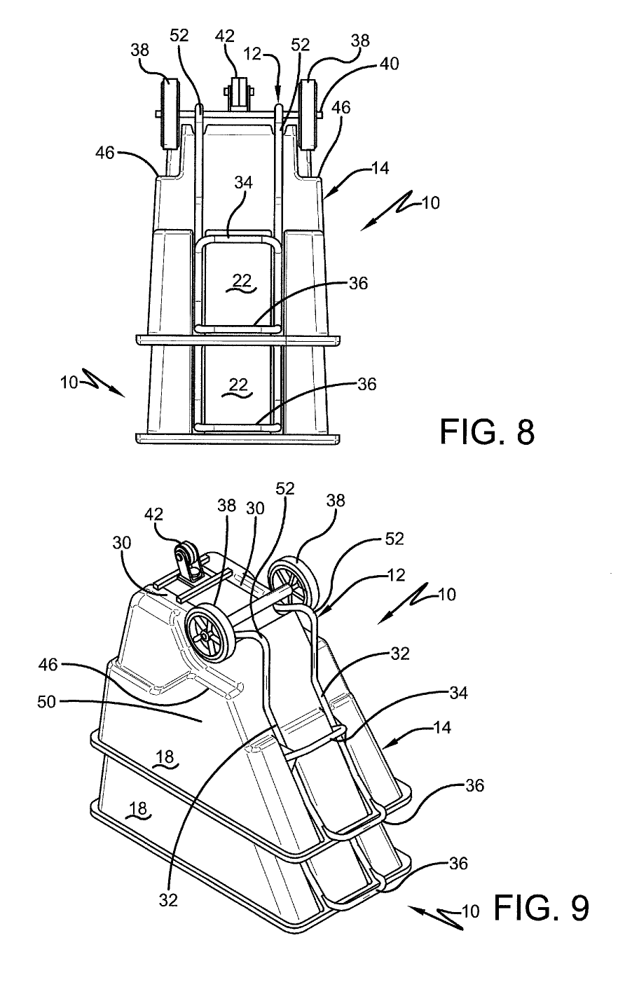

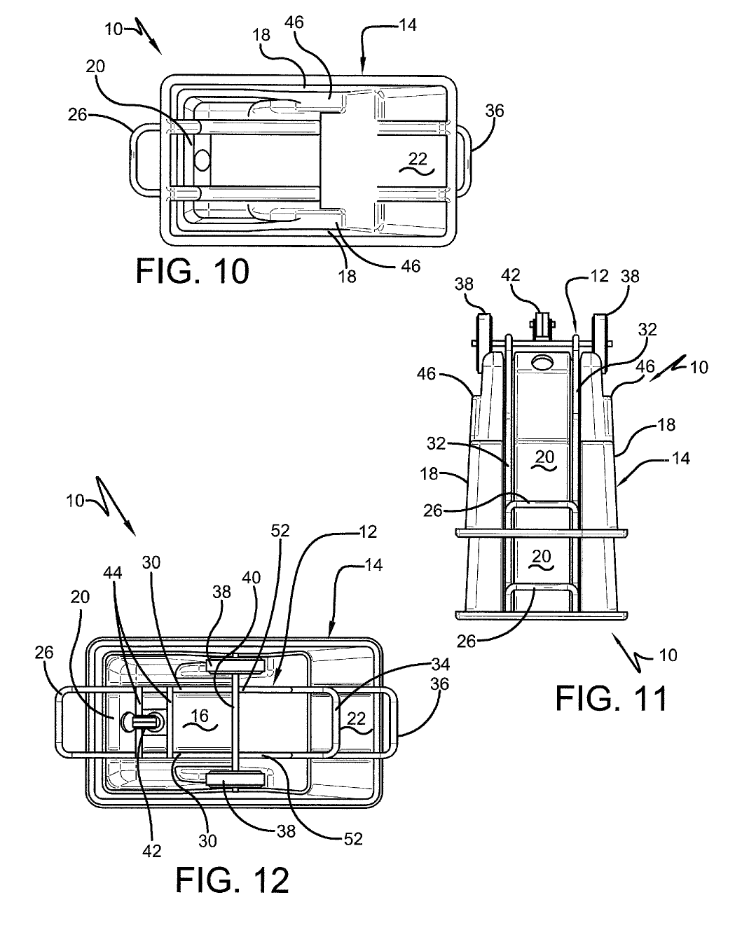

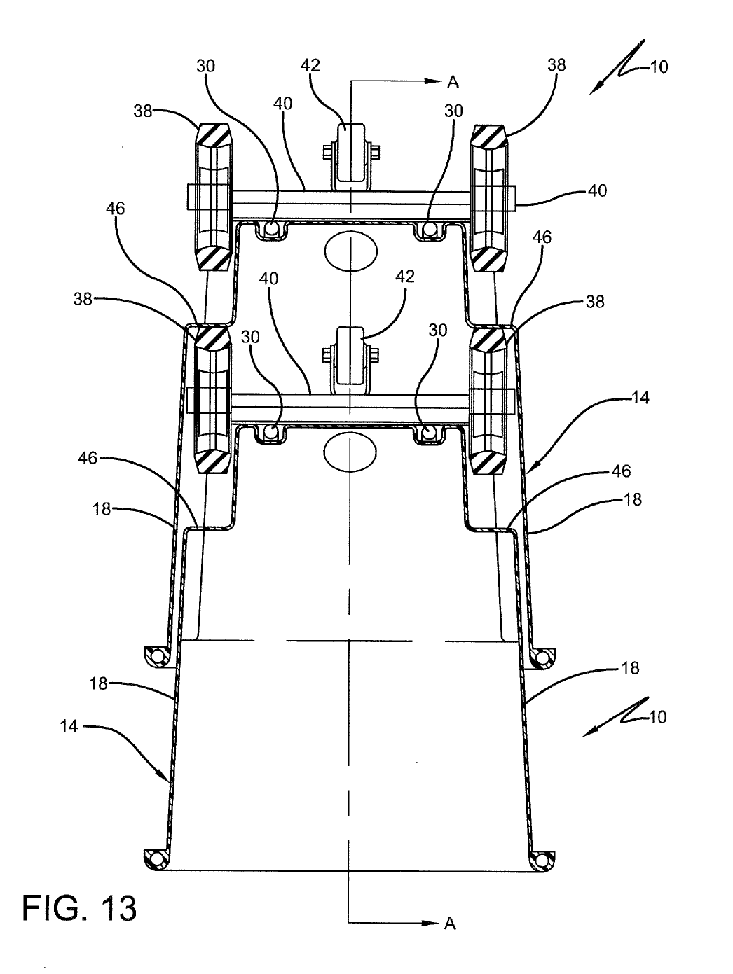

A first exemplary embodiment nesting tilt-truck of the present invention is shown generally in FIGS. 1-14 at reference numeral 10 and will be described in detail below.

First exemplary embodiment nesting tilt-truck 10 includes a metal frame 12 and a container body 14. Container body 14 is formed from plastic or other suitable material and includes a horizontal base 16 and a pair of generally mirror image vertical sidewalls 18 transversely spaced from one another and extending upwardly from the base. A rear wall 20 and a front wall 22 are longitudinally spaced from one another and extend upwardly from base 16 of container body 14. Front wall 22, rear wall 20, sidewalls 18 and base 16 are integrally formed with one another to form a generally box-like shape. Rear wall 20 is oriented in a generally vertical configuration. Front wall 22 is angled away from base 16 at approximately 125 degrees. It should be understood that front wall 22 could be angled away from base 16 at from about 120 degrees to about 130 degrees without changing the overall concept or operation of the present invention. Angled front wall 22 allows easy tilting of container body during use of tilt-truck 10.

Container body 14 is mounted on and attached to metal frame 12. Metal frame 12 is formed from tubular steel or other suitably rigid material. Metal frame 12 includes a pair of rails that are transversely spaced from one another. Metal frame 12 includes a rear frame portion 28, a base frame portion 30 and a front frame portion 32. Rear frame portion 28 extends downwardly along container body rear wall 20 and is seated within a pair of transversely spaced depressions formed in the exterior surface of the container body rear wall. Base frame portion 30 extends along container body base 16 and is seated within a pair of transversely spaced depressions formed in the exterior surface of the container body base. Front frame portion 32 is angled upwardly along container body front wall 22 and is seated within a pair of transversely spaced depressions formed in the upper portion of the exterior surface of the container body front wall. A rear handle 26 is attached to the upper end of rear frame portion 28. An intermediate handle 34 is attached to front frame portion 32. A primary handle 36 is attached to the end of front frame portion 32. A front wheel 38 is rotatably mounted on each end of a common front axle 40 that extends transversely between the rails of the front end of base frame portion 30. A rear caster wheel 42 is mounted between a pair of longitudinally spaced rear brackets 44 that extend transversely between the rails of the rear portion of base frame 30. Rear caster wheel 42 houses a self-contained axle that allows the wheel to rotate. In addition, rear caster wheel 42 is configured to pivot about a vertical axis in order to easily steer the tilt-truck during use of the tilt-truck. Front wheels 38 have a relatively large diameter compared to rear caster wheel 42. Front frame portion 32 includes a fulcrum 52 at its lower end that extends generally downwardly and frontwardly of wheel 38 and serves as a stop to engage the ground when nesting tilt-truck 10 is tilted forward in order to dump the contents of the tilt-truck during use.

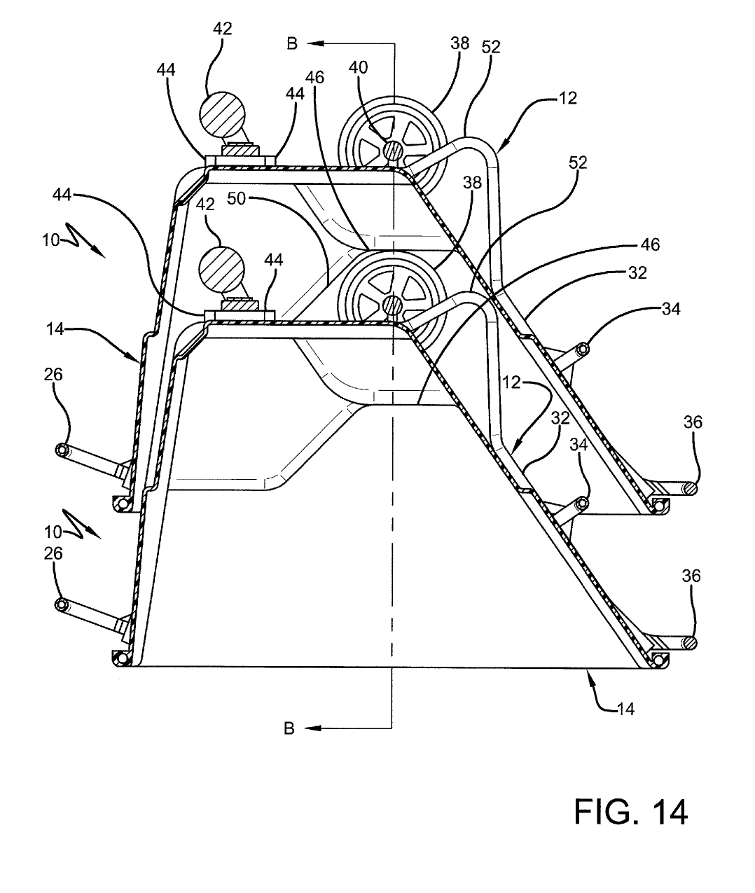

In accordance with an important feature of first exemplary embodiment nesting tilt-truck 10 of the present invention, the tilt-truck accommodates nesting of a first exemplary embodiment second tilt-truck 10. More particularly, first exemplary embodiment tilt-truck 10 of the present invention includes sidewalls 18 that are formed with a kick-out portion 46 that extends generally horizontally directly above wheel 38 from the front end of the sidewall to a location behind the wheel, and then inclines upwardly to a point generally above the front end of rear caster wheel 42. Kick-out wall 46 then extends generally horizontally again to the rear end of the sidewall. Kick-out wall 46 and container body front wall 22 form a pocket 50 where wheels 38 can seat when a second first exemplary nesting tilt-truck of the present invention is nested inside of the first exemplary embodiment nesting tilt-truck as shown in FIG. 14.

As is best shown in FIGS. 1, 2 and 3, sidewalls 18 are angled slightly inwardly extending downwardly to their respective integral connections with container body base 16. As a result, the transverse width between the upper portions of sidewalls 18 decreases from the top of the walls to their integral connection with container body base 16. In addition, container body front wall 22 is angled as described above and container body rear wall 20 is angled slightly inwardly extending downwardly to the integral connection with container body base 16. As a result, the longitudinal width of first exemplary embodiment nesting tilt-truck 10 decreases from the top of the container body front and rear walls to the integral connection with container body base 16. With particular reference to FIGS. 7-14, because the transverse and longitudinal width of first exemplary embodiment nesting tilt-truck 10 is greater near the top of the tilt-truck, there is adequate space for the exterior shape of a first exemplary embodiment second tilt-truck 10 to fit within the interior space of the first tilt-truck, thereby enabling simplified nesting of the tilt-trucks, as will now be described below.

With continued reference to FIGS. 7-14, when first exemplary embodiment nesting tilt-truck 10 is nested within a second first exemplary embodiment tilt-truck 10, front wheels 38 of the first tilt truck rest on kick-out wall 46 of the second tilt-truck, providing nesting support to the first tilt-truck. Additionally, fulcrum 52 of frame front portion 32 of the first exemplary embodiment tilt-truck rests against container body front wall 22 of the second tilt-truck to provide additional nesting support to the first and second tilt-trucks. The combination of kick-out wall 46, both the horizontal front and inclined intermediate portions, with wheels 38 and fulcrum 52, enables simple nesting during tilt-truck shipping and/or transport and prevents the first tilt-truck from becoming jammed or stuck within the second tilt-truck, enabling simple removal of the first tilt-truck from the second tilt-truck.

First exemplary embodiment nesting tilt-truck 10 of the present invention readily nests within a second tilt-truck, generally preventing both longitudinal and lateral movement of the tilt-trucks nested within each other, so that multiple tilt-trucks can be shipped or transported while nested together, saving space and providing for more efficient transport and shipment of the tilt-trucks.

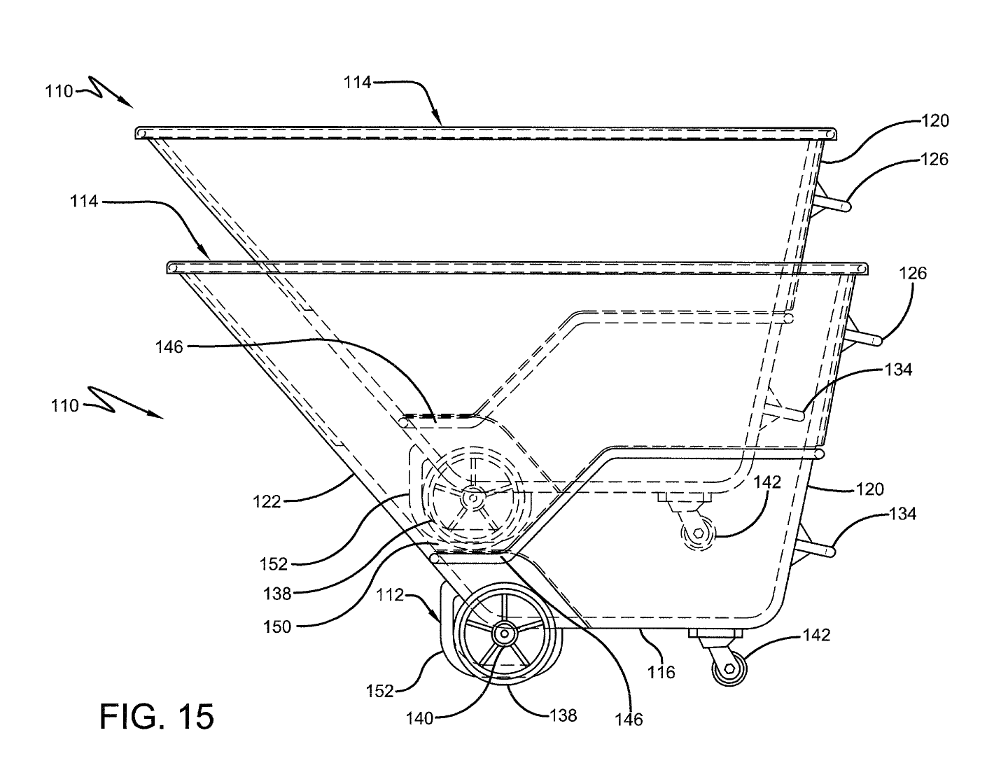

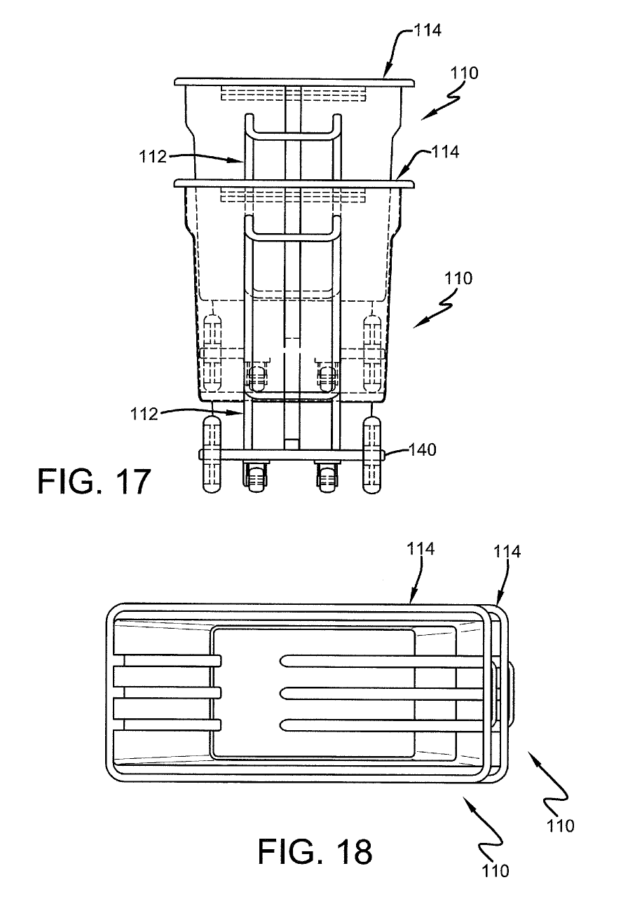

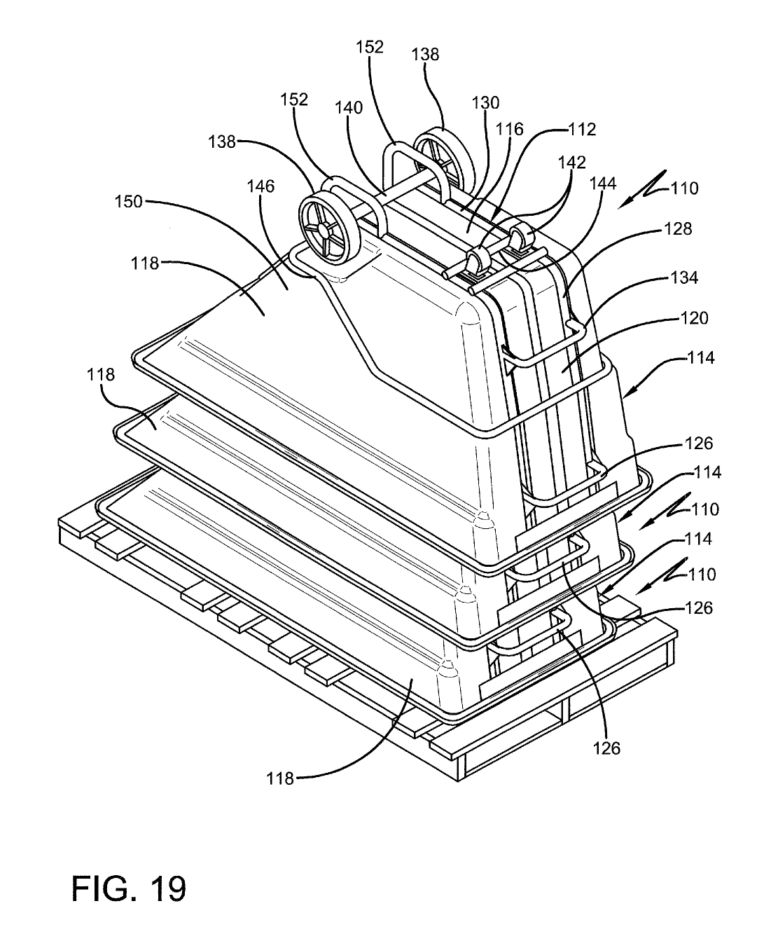

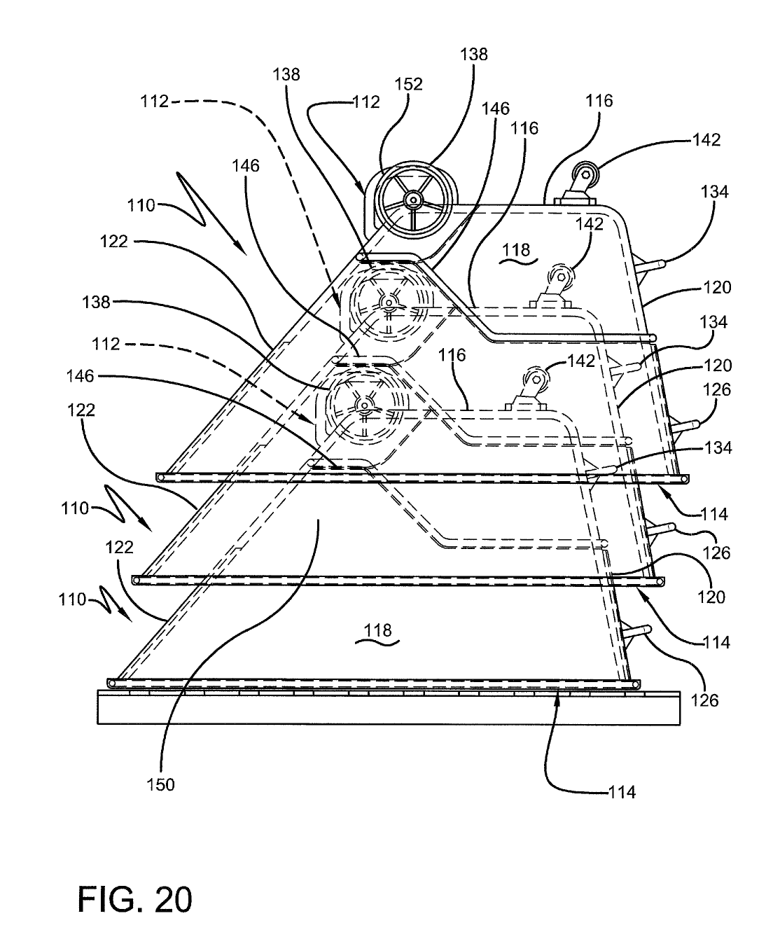

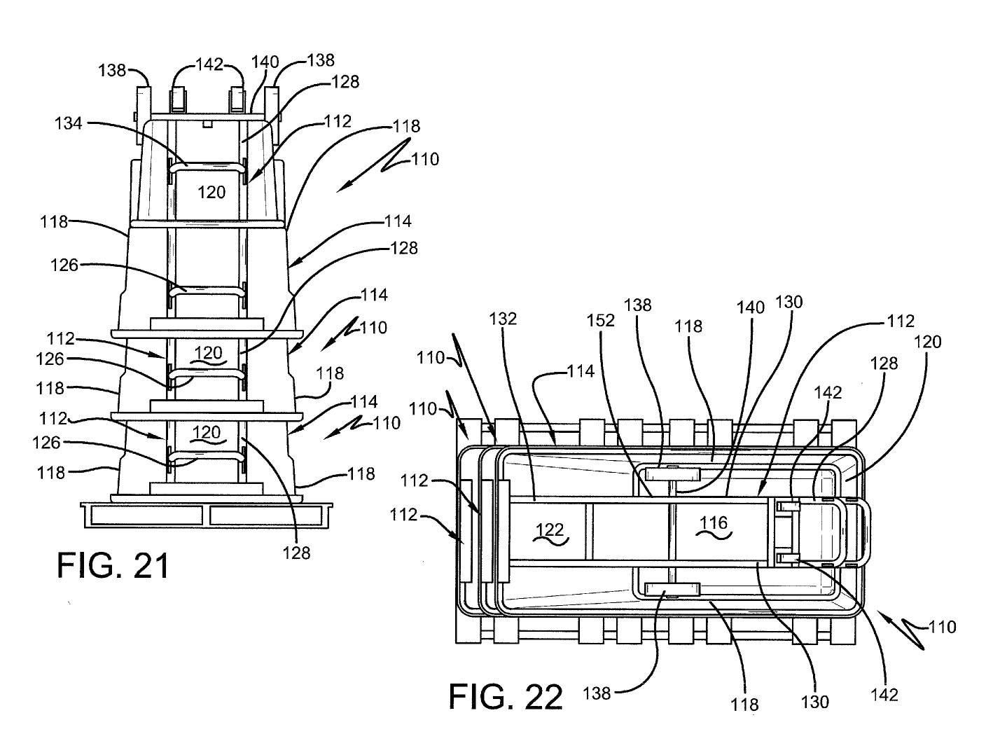

A second exemplary embodiment nesting tilt-truck of the present invention is shown generally in FIGS. 15-22 at reference numeral 110 and will now be described in detail below.

Second exemplary embodiment nesting tilt-truck 110 includes a metal frame 112 and a container body 114. Container body 114 is formed from plastic or other suitable material and includes a horizontal base 116, a pair of generally mirror image vertical sidewalls 118 transversely spaced from one another and extending upwardly from the base. A rear wall 120 and a front wall 122 are longitudinally spaced from one another and extend upwardly from base 116 of container body 114. Front wall 122, rear wall 120, sidewalls 118 and base 116 are integrally formed with one another to form a generally box-like shape. Rear wall 120 is oriented in a generally vertical configuration. Front wall 122 is angled away from base 116 at approximately 125 degrees. It should be understood that front wall 122 could be angled away from base 116 at from about 120 degrees to about 130 degrees without changing the overall concept or operation of the present invention. Angled front wall 122 allows easy tilting of container body during use of tilt-truck 110.

Container body 114 is mounted on and attached to metal frame 112. Metal frame 112 is formed from tubular steel or other suitably rigid material. Metal frame 112 includes a pair of rails that are transversely spaced from one another. Metal frame 112 includes a rear frame portion 128, a base frame portion 130 and a front frame portion 132. Rear frame portion 128 extends downwardly along container body rear wall 120 and is seated within a pair of transversely spaced depressions formed in the exterior surface of the container body rear wall. Base frame portion 130 extends along container body base 116 and is seated within a pair of transversely spaced depressions formed in the exterior surface of the container body base. Front frame portion 132 is angled upwardly along container body front wall 122 and is seated within a pair of transversely spaced depressions formed in the upper portion of the exterior surface of the container body front wall. A rear handle 126 is attached to the upper end of rear frame portion 128. An intermediate handle 134 is attached to the intermediate portion of rear frame portion 128. A front wheel 138 is rotatably mounted on each end of a front axle 140 that extends transversely between the rails of the front end of base frame portion 130. A pair of rear caster wheels 142 are mounted between a pair of longitudinally spaced rear brackets 144 that extend transversely between the rails of the rear portion of base frame 130. Rear caster wheels 142 each house a self-contained axle that allows the wheel to rotate. In addition, rear caster wheels 142 are configured to pivot about a vertical axis in order to easily steer the tilt-truck during use of the tilt-truck. Front wheels 138 have a relatively large diameter compared to rear caster wheels 142. Front frame portion 132 includes a fulcrum 152 at its lower end that extends generally downwardly and frontwardly of wheel 138 and attaches to base frame 130 and serves as a stop to engage the ground when nesting tilt-truck 110 is tilted forward in order to dump the contents of the tilt-truck during use.

In accordance with an important feature of second exemplary embodiment nesting tilt-truck 110 of the present invention, the tilt-truck accommodates nesting of another second exemplary embodiment tilt-truck 110. More particularly, second exemplary embodiment tilt-truck 110 of the present invention includes sidewalls 118 that are formed with a kick-out portion 146 that extends generally horizontally directly above wheel 138 from the front end of the sidewall to a location behind the wheel, and then inclines upwardly to a point generally above the middle portion of container body base 116. Kick-out wall 146 then extends generally horizontally again to the rear end of the sidewall. Kick-out wall 146 and container body front wall 122 form a pocket 150 where wheels 138 can seat when another second exemplary nesting tilt-truck of the present invention is nested inside of the second exemplary embodiment nesting tilt-truck as shown in FIGS. 15-22.

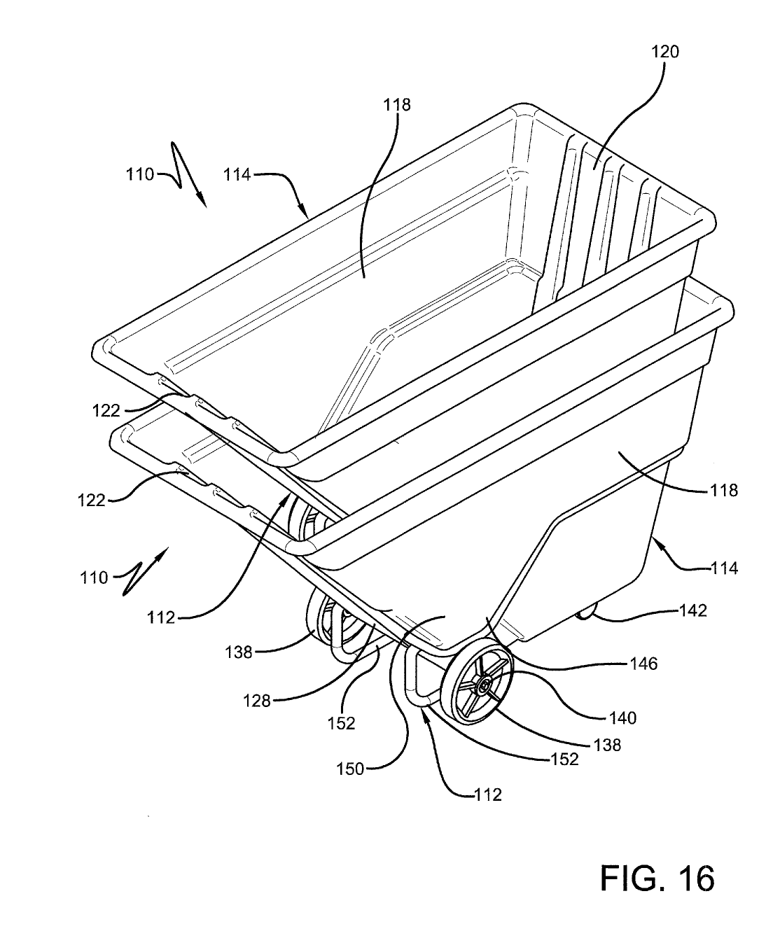

As is best shown in FIGS. 16, 17, 19 and 21, sidewalls 118 are angled slightly inwardly extending downwardly to their respective integral connections with container body base 116. As a result, the transverse width between the upper portions of sidewalls 118 decreases from the top of the walls to their integral connection with container body base 116. In addition, container body front wall 122 is angled as described above and container body rear wall 120 is angled slightly inwardly extending downwardly to the integral connection with container body base 116. As a result, the longitudinal width of second exemplary embodiment nesting tilt-truck 110 decreases from the top of the container body front and rear walls to the integral connection with container body base 116. Because the transverse and longitudinal width of second exemplary embodiment nesting tilt-truck 110 is greater near the top of the tilt-truck, there is adequate space for the exterior shape of another second exemplary embodiment tilt-truck 110 to fit within the interior space of the first tilt-truck, thereby enabling simplified nesting of the tilt-trucks, as will now be described below.

With continued reference to FIGS. 15-22, when second exemplary embodiment nesting tilt-truck 110 is nested within another second exemplary embodiment tilt-truck 110, front wheels 138 of the first tilt truck rest on kick-out wall 146 of the second tilt-truck, providing nesting support to the first tilt-truck. Additionally, fulcrum 152 of the second exemplary embodiment tilt-truck rests against container body front wall 122 of the second tilt-truck to provide additional nesting support to the first and second tilt-trucks. The combination of kick-out wall 146, both the front horizontal and inclined portions, with wheels 138 and fulcrum 152, enables simple nesting during tilt-truck shipping and/or transport and prevents the first tilt-truck from becoming jammed or stuck within the second tilt-truck, enabling simple removal of the first tilt-truck from the second tilt-truck. Second exemplary embodiment nesting tilt-truck 110 of the present invention readily nests within a second tilt-truck, generally preventing both longitudinal and lateral movement of the tilt-trucks nested within each other, so that multiple tilt-trucks can be shipped or transported while nested together, saving space and providing for more efficient transport and shipment of the tilt-trucks.

It is contemplated that the container body of the nesting tilt-truck of the present invention may be formed by any suitable means, such as thermoforming, injection molding, blow molding, roto-casting, and any other commonly used forming technique. It is also contemplated that the container body of the nesting tilt-truck of the present invention may be formed of any suitable material, such as polypropylene, polyethylene, polycarbonate, styrene methyl methacrylate acrylic blend, high impact polystyrene, and any other materials commonly used to manufacture polymeric parts. It is further contemplated that that the nesting tilt-truck of the present invention supports the nesting of one or more tilt-trucks without changing the overall concept or operation of the present invention.

It is to be understood that the structure and arrangements of the above-described nesting tilt-truck of the present invention may be altered or rearranged without affecting the overall concept or operation of the invention.

Accordingly, the nesting tilt-truck is simplified, provides an effective, safe, inexpensive, and efficient structure which achieves all the enumerated objectives, provides for eliminating difficulties encountered with prior art tilt-truck, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the present invention has been described with reference to a preferred embodiment. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved tilt-truck is constructed, arranged and used, the characteristics of the construction and arrangement, and the advantageous, new and useful results obtained; the new and useful structures, devices, elements, arrangements, parts and combinations are set forth in the appended claims.

What is claimed is:

1. A tilt-truck comprising:
a) A body, said body including a
a. a base;
b. a rear wall integrally formed with said base;
c. a first sidewall integrally formed with said base and said rear wall;
d. a second sidewall integrally formed with said base and said rear wall, said second sidewall transversely spaced from said first sidewall; and
e. a front wall integrally formed with said base, said first sidewall, and said second sidewall;
b) one or more wheels attached to said body, said tilt-truck body having an interior space which accommodates nesting of a second tilt-truck within said body, the tilt-truck having an exterior profile which enables said tilt-truck to be nested within an interior space of said second tilt-truck.

2. The tilt-truck of claim 1, wherein said front wall is angled away from said base at about 120 degrees to about 130 degrees.

3. The tilt-truck of claim 1, wherein said front wall is angled away from said base at about 125 degrees.

4. The tilt-truck of claim 1, wherein said second tilt-truck is a plurality of tilt-trucks.

5. The tilt-truck of claim 1 further comprising a frame attached to an exterior surface of said body.

6. The tilt-truck of claim 5, wherein said frame is formed of a metal.

7. The tilt-truck of claim 5, wherein said frame includes a fulcrum, said fulcrum contacting a surface of said second tilt-truck interior space when said tilt-truck nests within the second tilt-truck.

8. The tilt-truck of claim 7, wherein said fulcrum contacts an interior surface of a rear wall of said second tilt-truck.

9. The tilt-truck of claim 1, wherein said first sidewall and said second sidewall are each formed with a kick-out portion, one or more wheels of said second tilt-truck contacting said first sidewall kick-out portion and said second sidewall kick-out portion when the second tilt-truck nests within said tilt-truck interior space.

10. The tilt-truck of claim 9, said tilt-truck further comprising a frame attached to an exterior surface of said body, said frame contacting a surface of said second tilt-truck interior space when the tilt-truck nests within the second tilt-truck interior space.

11. The tilt-truck of claim 10, wherein said frame includes a handle, said handle contacting said second tilt-truck interior space surface when said tilt-truck nests within said second tilt-truck interior space.

12. The tilt-truck of claim 11, wherein said handle contacts an interior surface of a front wall of said second tilt-truck.

13. The tilt-truck of claim 10, wherein said frame includes a fulcrum, said fulcrum contacting said second tilt-truck interior space surface when said tilt-truck nests within said second tilt-truck interior space.

14. The tilt-truck of claim 13, wherein said fulcrum contacts an interior surface of a rear wall of said second tilt-truck.

15. The tilt-truck of claim 1, wherein said body is formed from a material of the group consisting of polypropylene, polyethylene, polycarbonate, styrene methyl methacrylate acrylic blend, and high impact polystyrene.
